(19) United States
(12) Patent Application Publication
(10) Pub. No.: US 2017/0183196 A1
(43) Pub. Date: Jun. 29, 2017

(54) CABLE SPOOL

(71) Applicant: Matthew KENNEDY, Chilliwack (CA)

(72) Inventor: Matthew KENNEDY, Chilliwack (CA)

(21) Appl. No.: 15/185,777

(22) Filed: Jun. 17, 2016

(30) Foreign Application Priority Data
Dec. 23, 2015 (CA) 2916270

(51) Int. Cl. B65H 75/14; H02G 11/02; B65H 75/28

(52) U.S. Cl. CPC B65H 75/14; B65H 75/28; H02G 11/02

(57) ABSTRACT

The invention is a circular cable spool with an internal perimeter disposable to retain a power adaptor at its distal portions by friction fit. In most embodiments, sidewalls of the spool will extend axially and distally from opposite ends of the circular spooling surface, disposed to spool and retain a cable between them. Power adaptors intended for electronic devices are, in general, nominally square or rectangular in profile (typically ‘box-like’ in volume), whether the corners of the adaptors have radii or not. In order to retain a square power adaptor within a round interior perimeter, the adaptor must be held at its distal portions by friction, generally at its corner portions, to the interior perimeter of the spool. Accommodations in the design of the cable spool allow the tangs of the power adaptor to straddle the spool, by limiting the thickness of the spool to fit between the tangs, as provided by a radius between the interior perimeter and a sidewall, and further by including a relief slot in a sidewall or interior perimeter that facilitates insertion of the adaptor within the interior perimeter of the spool. Accommodating the tangs to fit around the spool in such as manner in measure to facilitate the assembly of the adaptor within the interior perimeter provides a more compact assembly, desirable for transporting portable devices and their cables and adaptors together in an organized fashion.

### FIELD

### BACKGROUND OF THE INVENTION

Users of electronic devices often find that the cables used with them get tangled, whether they are power, audio or data cables, which is compounded when unspooled cable is gathered for transport and mixed with other cables. Tangled cables can lead to knotting and kinking, are less usable in deployment, and can be frustrating and time-consuming to untangle. Untangling can lead to strain on cables that can wear out the cable jacketing and damage the operational portion of the cable.

Cable spools exist for spooling cables in a compact, organized fashion to keep them from tangling and make them easy for transport. Spools have a long history in storing and maintaining long lengths of thread, rope and chain in an organized manner from which they can be unspooled to great lengths without risk of tangling. As an added benefit, some cable spools have been fashioned to transport power adaptors for electronic devices along with the cables used with them to keep them together and organized.

The rise and growth of use of portable electronic devices such as cellular phones, smartphones, audio playback devices, tablets, laptops and other portable computing devices has made cable management an important and ongoing issue in the daily lives of many people. Industrial use of portable electronic devices such as surveying equipment, GPS devices, audio, video and photographic equipment used in film, television, print and web production, and environmental testing equipment also experiences the same issues. People that frequently travel, or transport electronic devices between home and work, or between office and field work, necessarily transport many cables for their various electronic devices and would benefit from portable cable organizational spooling devices, especially so if they also work to organize and retain power adaptors or the principal devices the cables are used with.

Spools provide means for spooling and organizing lengths of cable for storage and transport. Circular spools of ample diameter for the cable used provide superior means for spooling cable as they fully support a cable being wound around them and prevent the sharp bending of cable that would occur around corners of other spool fashions that can cause kinking and damage to the cable, especially after repeated cycles of winding and unwinding. They are preferable to spooling a cable around a small diameter post or a spooling portion with corners, whether they have a radius or not, or wrapping a cable around a flat plate, all of which cause a cable to bend too tightly for its cross-sectional composition and diameter that determines the limit of its flexibility and the point where a cable may kink, strained, or otherwise be damaged. Wrapping a cord around a flat plate causes kinking of the cable wrapped around them, and spooling around a spool with corners or small radii causes stress and strain to the cable and cable jacketing, both variations causing concentrated forces on points of the cable that eventually leads to wear and tear that will shorten the aesthetic and functional life of the cable.

Commercially available cable spools such as those offered by Cable Turtle (NL1003471), and XL have circular, but relatively small diameter spooling posts relative to the cords advertised for use with them. The tight wrapping of cords around a narrow spool post may cause kinking and strain on a cord and its jacket. These spools also feature flexible cable retention features (‘lips’) that the cord is conceivably wound into and out of; Though the Cable Turtle is designed with a flexible housing to flex open to deploy cable, in practice use users often pull a cord out of the lips that retain it during unspooling. These retention features introduce friction to the cord during spooling and unspooling that will cause stress to the jacketing, eventually leading to it wearing out and exposing cables within and lead to a shortened useable life of the cable.

Cable spools such as those offered by Nice and Quirky provide a recess to store a power adaptor at a portion of their cable spools. As power adaptors, such as those offered by Apple Inc. for their iPhone and MacBook products, are generally squarish blocks the recesses provided for them by these examples are also square shaped to fit them. Likewise, since the material of those spools comprises both the perimeter of the recess and that of the spooling portion, the spooling surface is not circular but a squarish shape derived from the shape of the power adaptor device. As indicated, this is undesirable due to the stresses these corners can impose on a cord wrapped around them. As a cable is wrapped around these square or square-like spooling surfaces, the cable is compressed around tight corners of the spool, even if they have radii, which can cause kinking, strain and damage to the cable.

### Specification

The invention is a round cable spool with a circular internal perimeter disposed to retain a power adaptor by friction fitting within the circular internal perimeter the nominally square or rectangular adaptor at the distal portions of the adaptor, generally its corners, whether they are sharp or have radii. Therefore a square adaptor would be retained within a circular internal perimeter in the cable spool with its four corners making physical contact with the material of the internal perimeter of the spool.

This invention discloses an internal perimeter of a cable spool circular in shape to maintain even spooling of cable over a nominally diametrical spooling surface to fully support a cable as it is layered around the spool during spooling, where a circular interior perimeter of the spool is designed to fit a specific adaptor, by inserting the squarish adaptor within the internal perimeter of the spool where it is retained by friction or pressure fit at the corners or distal portions of the adapter at the surface of the circular internal perimeter. This is in contrast to cable spools that have recesses shaped to fit the shape of a square or rectangular adaptor.

As the internal perimeter is round, the spooling surface is also round. As adaptors are typically large in size relative to the diameter of a cable associated with it, the spooling surfaces of specific spools disposed around the adaptor are by design generally larger than the minimum required bend radius for the cable. Circular spools with large diameters relative to cable diameter provide the added benefit in lessening the impact of spooling on a cable and prevent sharp bending or kinking of a cable during spooling. The cable spool generally has sidewalls that extend distally from the spooling surface to retain the cable within during spooling.

Embodiments are intended to store a power adaptor within an internal perimeter of a cable spool that is also intended to store the cable or cables associated with the adaptor, whether they are fixed to the adaptor or removable, thus keeping the cable and adaptor together in an organized fashion. This is particularly advantageous for cables and adaptors for portable devices, allowing for compact portability and organization of an adaptor and its associated cable or cables together.

The circular interior perimeter of the spool also has the aesthetic advantage of appearing simple and uncomplicated, and can be used without an adaptor without appearing unused. The relatively large void delineated by the circular interior perimeter also appears to lessen to physical presence of a cable spool, despite embodiments having a large diameter, and the void presents opportunity for fingers to grip the spool therein, making handling of the spool easier.

When a spool is part of a family of spools wherein each are designed to fit different adaptors, the family collection has the aesthetic advantage of appearing of the same general design without obvious variations of the central interior perimeter. Each would have the same basic design of a circular central perimeter, regardless of the actual shape or size of the adaptor each was designed to retain.

The invention is generally to be made from hard or elastomeric injection molded plastics or silicones. Elastomers, like silicone, provide an advantage over hard plastics or other hard materials in that the internal perimeter diameter can be made slightly smaller than a diameter required to exactly fit the corners (or distal portions) of the adaptor so that the adaptor compresses the elastomeric material during insertion to allow better retention through compression. This also provides greater allowances for tolerance in the dimensions of the cable spool and the adaptor. Elastomers also allow other features to be more easily molded, such as flexible portions intended to allow entry of a cable and retaining them therein. Elastomers, especially silicones, generally have excellent dielectric properties. Silicone, in particular, is advantageous in that it is generally heat and fire resistant (having high temperature ratings), which is suitable for use with electrical equipment in unpredictable environments, and also has low compression set properties unlike most thermoplastic elastomers.

In order to make the internal perimeter of the invention nominally coincident to the distal portions of the adaptor, a cable organizer is designed to specifically fit a specific adaptor's dimensions, correlating the distal portions of the adaptor to be nominally coincident to the interior perimeter of the cable spool upon insertion. While at first evaluation this may seem limiting to use, the portable electronic device market has massive quantities of devices and their associated adaptors in use from companies such as Apple Inc., Samsung, and Blackberry, for example. A cable spool designed to retain an iPhone adaptor, or iPad adaptor, for example, has significant marketability and appeals directly to the users of those devices. As the invention can be designed to accommodate specific power adaptors, then a different and specific cable spool is required for a user's different devices, broadening the market penetration of the invention.

Where a power adaptor is smaller than the diameter of a spool's internal perimeter, it may be loosely placed inside the internal perimeter during storage. If the power adaptor also has a cable wound around the spool, then the adaptor is effectively, if loosely supported by the spool.

In one embodiment, a power adaptor will feature conductive tangs (also known as pins, or blades) extending from the body of the adaptor, conventionally referred to as the ‘plug’ end. With these adaptor types, the invention can be designed such that the friction fit of the adaptor to the interior perimeter can be made at the distal portions of the body of the adaptor at one end, and the distal portions of the tangs at the other. Another embodiment may have a slot or holes to receive the tangs of an adaptor.

In another embodiment, the tangs of an adaptor can be fitted around portions of the cable spool during insertion, straddling the sidewalls or a retention tab, for example. The sidewalls of the cable organizer can be designed to fit between the tangs of the adaptor upon insertion of the adaptor. The width of the cable spool retained between the tangs must be equal or less than the available width between the tangs. In example, an adaptor may have NEMA 1-15 ungrounded (Type A) styled tangs extending from its body, which measure approximately 7/16″ (approximately 11 mm) between tangs: thus the width of the cable spool retained between the tangs must be this dimension, or less. In effect, the adaptor is fixed to the cable spool at the tangs.

In order to make the cable spool more compact, however, the diameter of the internal perimeter can be smaller than the overall length of the adaptor with its tangs; this also allows the body of the adaptor to be friction fitted to the interior perimeter regardless of the tangs. In embodiments of the invention where the tangs are parallel to a central axis of the spool, the spool may be retained to the adaptor when it is inserted into a power socket, such as a wall socket. While the spool may be more compact, the assembly of the spool with the adaptor would generally have an overall greater thickness than the next described embodiment, considering the tangs protruding from the spool, and therefore less easy to insert into a pocket or sleeve in pants, jacket, bag or briefcase.

Therefore, preferred embodiments are designed to permit the tangs oriented perpendicular to the main axis of the spool where they may straddle portions of the spool such as the sidewalls in order to keep the entire assembly as compact as possible in order to facilitate storing the device in places as described where available space is restricted. Likewise, preferred embodiments orient the wider portions of an adaptor parallel to the wider portion of the spool to make the assembly as flat as possible, rather than orienting them perpendicular to each other which would make the assembly redundantly large in multiple dimensions.

In some embodiments, where the thickness of the spool approximates but is less than the dimension between the tangs, the insertion of the tangs around the spool will require a certain amount of non-destructive flexibility of the tangs and spool in order to fit during insertion. Forcing the assembly, however, may present opportunity to damage either the tangs, adaptor or spool. Therefore, a relief slot, or slots, in the interior perimeter or sidewall of the invention may be disposed to provide ease of insertion of the tangs around the spool at the interior perimeter by effectively reducing the thickness there, reducing or eliminating strain on the tangs or spool. Once inserted, the adaptor can be rotated within the internal perimeter to a point where the tangs are no longer at the position of the relief slot, thereby constraining the assembly that physically retains the adaptor against knock-out. This is especially helpful while transporting adaptors for portable devices, which can be dropped, or jostled, however they may be transported. In order to release the adaptor, it is rotated to the position where the tangs are at the relief slot, and then the adaptor is levered out of the opening at the internal perimeter. Generally, however, rotating the adaptor to a secondary retention position is an added benefit and not always required.

Some power adaptors feature fully or partially retractable plugs, which present no or less issue with interference with the body of the cable spool. Where a cable spool is thicker than the distance between tangs of a power adaptor that protrude from the adaptor, portions of the tangs that extend distally from the adaptor can be accommodated by making a notch or notches at, or making a radius or radii at the edges of the interior perimeter to allow the tangs to fit thereat without interference.

Embodiments may feature slots, slits or holes in the sidewalls, the interior perimeter or other portions of the spool to provide means to pass a cable through and hooking the cable into place either prior or after spooling. Likewise, embodiments may feature flanges to retain cables or plugs around the perimeter of the spool. Some embodiments may feature discreet flanges around a perimeter of a spool's distal sidewall to retain a portion of the cable without necessitating passing the cable into or out of a retention flange imposing friction on a cable that surrounds the entire circumference of the spool, which, as disclosed herein, would cause undo strain to the jacketing of a cable.

Relief slots in the sidewalls may also be used to insert or exit an end of a cable into or from a cable spool. As a cable is spooled or unspooled on a cable spool, it may be hooked at a selected unspooled cable length into a slot. Employing a number of slots permits a greater selection of cable lengths left unspooled for deployment in use or storage, however a circular array of three slots on a sidewall is generally sufficient to prevent redundancy and lessening the integrity of the sidewall. Elastomeric materials benefit the design by permitting the use of a flexible portion of the material at a slit in a sidewall to retain the cable within the slot, the entranceway to the slot being a slit narrower than the cable but, being flexible, the material of the sidewall can be flexed open at the slit to allow entry of the cable therein to the slot.

A portion of the spool around a cable slot also benefits inserting and retaining a cable by having a narrowing of the material of the spool closer to the slot so that the cable requires less bending to enter or exit the slot, the thinness of the there material around the slot also making the portion more flexible to accommodate pressures influenced on it by the cable.

Embodiments may feature cord-plug retention means that are in-line with the manner of spooling, retaining the plug-end of a cord between the sidewalls of a spool to prevent a plug-end from extending distally or laterally from a sidewall of the spool that would be anaesthetic and difficult to stop compactly.

An interior portion of the cable spool between the sidewalls may have a portion defined by flanges extending from or a slot within a sidewall to retain a plug-end of a cable therein to hold the cable prior to spooling so that the cable is gripped to prevent the plug-end from just spinning around and preventing spooling during the act of moving the cable around the spool.

In some embodiments, a flange or flanges extends interiorly from a sidewall or sidewalls of a cable spool so that a cord can be inserted between the flanges and its plug-end is drawn toward the flanges where it becomes fixed in place prior to spooling. This allows one hand to hold the spool, the other to draw and spool the cable, while the retention flanges holds the cable.

Likewise, in other embodiments, a recess is disposed to receive a plug that can be pushed into the recess by hand or with another device, such as using an opposing plug-end of a cable to push the other plug-end into the recess. In yet another embodiment, a slot in a portion of the interior perimeter allows a plug-end to be inserted and retained prior to the cable being spooled around. The benefit of each of these three variants over hooking the cable through a slot in a sidewall is that the retained plug-end doesn't extend beyond any perimeter of the spool that would make it thicker, being aesthetically unappealing or more difficult to insert into a compact space for storage.

Embodiments may feature plug retention means at a distal perimeter of a spool between sidewalls of the spool. Once the cable is nominally spooled within the sidewalls of the cable spool, a distal plug-end may be inserted between the sidewalls to retain it by friction or pressure fit. An added lip or flange at an interior portion of the sidewall, such as around the interior portion of the distal perimeter of the sidewall, may be disposed to retain the thick plug-end, such as a USB plug, without obstructing the spooling of a thinner cable around the spool, as the plug-end is larger than the cable and the lip or flange is intended only to hold the plug by retention or friction and not to obstruct the movement of the cable.

In those embodiments where both plug-ends are fastened to a spool between the sidewalls of the spool, then the complete assembly of the cable and spool is considered to be flat and compact and easier to store in compact, narrow spaces such as pockets or sleeves. In such embodiments, where both plug-ends of a cable are connected to a spool by features between the sidewalls, holes or slots for hooking and retaining cable is unnecessary.

An embodiment features a recess in a sidewall of a cable spool disposed to receive a Lightning™ plug of an Apple Inc. cable. The Lightning™ plug is placed adjacent to the slot and, with the USB plug at the other end of the cable, the Lightning™ plug is pushed into the slot, deforming the elastomeric material of the spool until it pops into the slot, where it is considered retained in place. By having one plug-end of a cable retained, the hands are free to hold and spool the remaining cable around the spool. Once the plug is retained therein, the cable may be spooled around the spool, spooling over the recessed Lightning™ plug to spool in a smooth and seamless fashion, preventing any significant bulging of the cable or deformation of the cable during spooling. The cable is then spooled until fully encompassed by the spool, and the distal USB plug-end is inserted between the sidewalls in a friction fit to retain it in a compact manner.

It is plausible that a power adaptor could be held at two points within the internal perimeter, but is better held by at least three points and better still at four.

The cable spool may be integrated within other products, such as a blender, lamp or other household appliance, GPS device, battery, or other portable or fixed devices, to comprise a discreet or integral component of the assembly.

The term cable as used herein is synonymous with wire, cord and the like. The term cable spool is synonymous with cable organizer and the like. The term power adaptor is synonymous with power block, power device, charger and the like, and may be substituted by any object if purpose dictates usefulness. The terms slot and hole may be used interchangeably. The term radius may be substituted by the terms notch or chamfer. The term Figure may alternatively be termed FIG.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of a first embodiment of cable spool, showing a nominally circular, flat cable spool with a circular interior perimeter and a slot in a sidewall.

FIG. 2 is a perspective view of the first embodiment of cable spool illustrated in FIG. 1, showing an adjacent power adaptor in a position prior to installation into the interior perimeter.

FIG. 3 is a perspective view of the first embodiment of cable spool illustrated in FIG. 1, with a power adaptor shown at an intermediary position during power adaptor insertion into the interior perimeter.

FIG. 4 is a side view of the first embodiment of cable spool illustrated in FIG. 3, shown at an intermediary position during power adaptor insertion into the interior perimeter.

FIG. 5 is a top elevation view of the first embodiment of cable organizer illustrated in FIG. 3.

FIG. 6 is a side elevation view, in section, of the first embodiment of cable organizer, taken along section lines A-A of FIG. 5.

FIG. 7 is a perspective view of a first embodiment of cable spool, with power adaptor of FIG. 2 shown in a stored position, showing distal portions of the adaptor fitted with the circular interior perimeter of the spool, where the embodiment of the adaptor features tangs that straddle the spool.

FIG. 8 is a top plan view of a first embodiment of cable spool, with power adaptor of FIG. 7 shown in a stored position, clearly showing the distal portions of the adaptor coincident with the interior perimeter of the cable spool.

FIG. 9 is a side elevation view, in section, of the first embodiment of a cable spool, taken along section lines B-B of FIG. 8.

FIG. 10 is a perspective of view of the first embodiment of a cable spool, shown in FIG. 7, where the adaptor is rotated so that the tangs are moved away from a slot on a sidewall of the spool.

FIG. 11 is a perspective view of a second embodiment of a cable spool, shown at the commencement of power adaptor insertion.

FIG. 12 is a perspective view of the second embodiment of cable spool illustrated in FIG. 11, shown at the termination of power adaptor insertion, showing distal portions of the adaptor fitted with the circular interior perimeter of the spool.

FIG. 13 is a top plan view of the second embodiment of cable spool illustrated in FIG. 12, shown at the termination of power adaptor insertion, clearly showing the distal portions of the adaptor coincident with the interior perimeter of the cable spool.

FIG. 14 is a perspective view of a third embodiment of cable spool, shown at the termination of power adaptor insertion.

FIG. 15 is a top plan view of the third embodiment of cable spool illustrated in FIG. 14, shown at the termination of power adaptor insertion, clearly showing the distal portions of the adaptor coincident with the interior perimeter of the cable spool, where the tangs protruding from the adaptor straddle a radius on the interior perimeter of the cable spool disposed to receive them.

FIGS. 16 to 26 are views of a fourth embodiment of a cable spool.

FIG. 16 is a perspective view of the fourth embodiment of a cable spool, revealing thin flexible edges 52 around a slot 44 and a plug retention flange 54.

FIG. 17 is a perspective view of the fourth embodiment of a cable spool, showing a cable 60 hooked into a slot 44 in a sidewall 42, where the cable 60 is able to lie flatter due to thin flexible edges 52 around the slot 44.

FIG. 18 is a perspective view of the fourth embodiment of a cable spool, revealing a slot 44 through a spooling surface 38 to an interior perimeter 34 that provides a means to hook a proximal plug 62 (not shown) of a cable 60 (not shown) therein, and a plug retainer 56 in the form of a recess disposed to retain a proximal plug 62 (not shown).

FIG. 19 is a side view of the fourth embodiment, revealing similar aspects as FIG. 18.

FIG. 20 is a section view along section line C-C as seen in FIG. 19.

FIG. 21 is a perspective view of the fourth embodiment shown with a cable 60 in proximity, with a proximal plug 62 and a distal plug 64 at either end of the cable 60, positioned in a first step of assembling the cable 60 to the cable spool 30.

FIG. 22 is a perspective view of the spool 30 and cable 60 of FIG. 21 showing a second step of assembly, where the distal plug 64 is used to push the proximal plug 62 into a plug retainer 56.

FIG. 23 is a perspective view of the spool 30 and cable 60 of FIG. 22 showing a third step of assembly, where the cable 60 is looped around the spool 30, prior to spooling the cable 60 into the spool 30.

FIG. 24 is a perspective view of the spool 30 and cable 60 of FIG. 23 showing a fourth step of assembly, where the cable 60 is fully spooled around spool 30, showing the distal plug 64 retained between the sidewalls 42 of the spool 30 by friction fit, aided by plug retention flanges 54 extending from the interior portion of the sidewalls 42 that provide grip to the distal plug 64 during insertion while freely allowing the passage of the cable 60 into the gap 40 during spooling.

FIG. 25 is a top view of the assembly of FIG. 24.

FIG. 26 is a section view along section line D-D as seen in FIG. 25, revealing cable 60 within the spool 30 and a proximal plug 62 retained within the plug retainer 56 fashioned as a recess in either sidewall 42 of the spool 30 within the gap 40.

### TERMS

The following terms are referenced in the drawings and written application:

30 cable spool

32 adaptor

34 interior perimeter

35 distal portions

38 spooling surface

40 gap

42 sidewalls

43 distal perimeter

44 slot

46 tang

48 radius

50 slit

52 thin flexible edge

54 plug retention flange

56 plug retainer

58 interior perimeter slot

60 cable

62 proximal plug

64 distal plug

### DETAILED DESCRIPTION

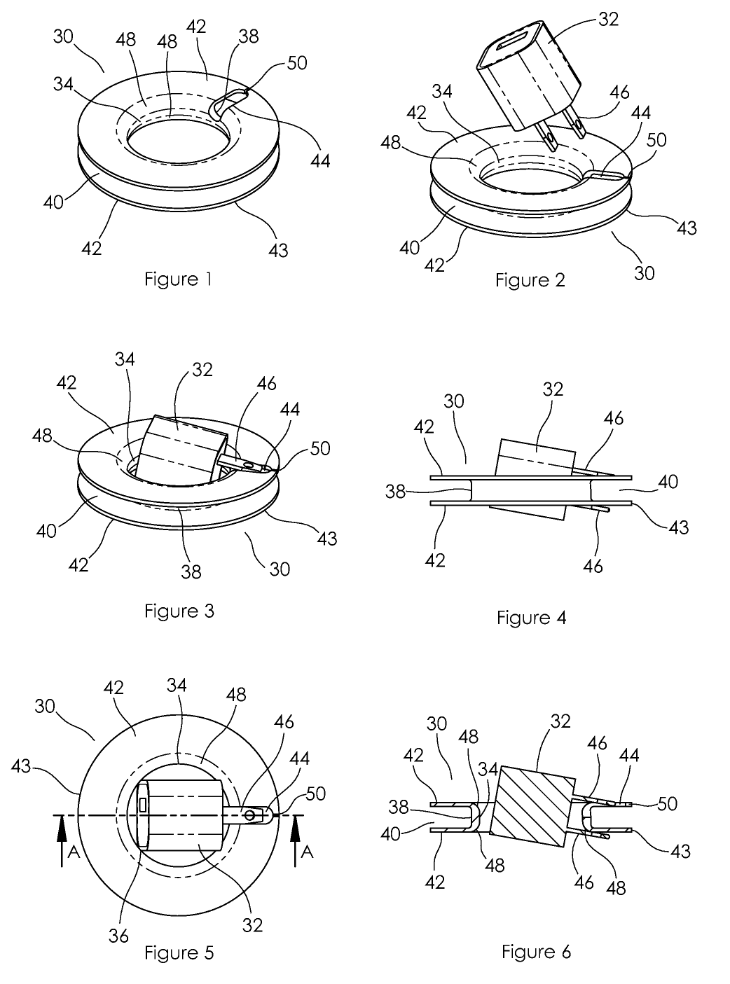

A cable spool generally identified by reference numeral 30, will now be described with reference to FIGS. 1 through 26.

### Structure and Relationship of Parts:

A cable spool 30, as depicted in FIGS. 1 to 10, features a nominally circular interior perimeter 34 separated from a nominally circular spooling surface 38 by the material wall thickness of the spool 30. Sidewalls 42 extend distally from the spooling surface 38, having a distal perimeter 43 generally circular in design typically with a theoretical center coincident with that of the interior perimeter 34. Between sidewalls 42 is a gap 40 into which cable (not shown) can be introduced and spooled around the spooling surface 38, the sidewalls 42 retaining a cable therein the gap 40.

Preferred embodiments have sidewalls 42 that are nominally parallel to each other to maintain a flat, compact design. Preferred embodiments also feature a radius 48 between the interior perimeter 34 and a sidewall 42 for aesthetic and functional purposes described in the ‘operation’ section of this application.

Some embodiments also feature a slit 50 in sidewall 42 providing access of a cable (not shown) to a position within a slot 44, the material of sidewall 42 being elastomeric so as to deform at slit 50 to allow access of the cable therethrough, where it is considered fixedly retained therein slot 44. Multiple slits 50 and slots 44 may feature on the spool 30.

Though embodiments feature parallel sidewalls 42, radii 48, a slot 44 and slit 50, these features may be absent or modified in form in some alternative embodiments. Embodiments with slots feature a circular array of three slots 44 and slits 50 on a sidewall 42 of a spool 30 in preferred embodiments for aesthetic reasons and for the purpose of choosing a specific length of cable to be retained exteriorly of the cable spool 30. Three slots 44 and slits 50 provides ample variation of cable length selection without being overly redundant in number of slots 44 and slits 50.

### Operation:

FIG. 1 depicts a cable spool 30 featuring a circular interior perimeter 34, designed to friction fit an adaptor 32 (not shown) at its distal portions 36. Cable (not shown) can be spooled around spooling surface 38, accessible by passing a cable through gap 40 between sidewalls 42 of the cable spool 30, until the cable comes to rest against spooling surface 38, and is spooled around the spool 30 to retain and store it within the sidewalls 42. A plug end of the cable (not shown) placed within the gap 40 may rest against the spooling surface 38 of the spool 30, or be passed through a slot 44 in a sidewall 42 or interior perimeter 34 where it can be hooked and retained to aid as a brace for the cable during spooling.

FIG. 2 is a perspective view of the first embodiment of cable spool 30 of FIG. 1, showing an adjacent power adaptor 32 in a position prior to installation into the interior perimeter, and showing the placement of tangs 46 of the power adaptor 32 adjacent to a slot 44 in the spool 30.

FIG. 3 is a perspective view of the first embodiment of cable spool 30, with a power adaptor 32 shown at an intermediary position during power adaptor 32 insertion into an interior perimeter 34 of the spool 30. A slot 44 is disposed to provide means to receive an anterior (as depicted in this figure) tang 46 of adaptor 32 to enter the slot 44 to avoid interference during assembly of power adaptor 32 to spool 30. FIG. 3 also depicts a radius 48 joining the interior perimeter 34 with a sidewall 42, disposed to provide means to receive tangentially a posterior tang 46 of adaptor 32 to avoid interference during assembly of adaptor 32 to spool 30; radius 48 may alternatively be fashioned as a notch (not shown) for similar purposes or providing relief space for tangs 46.

FIGS. 4 to 6 show alternative views of the spool 30 and adaptor 32 of FIG. 3 in the process of installation, clearly showing a tang 46 of the adaptor 32 recessed in a slot 44, and another tang 46 resting tangentially against a radius 48 as the adaptor 32 is inserted into the interior perimeter 34.

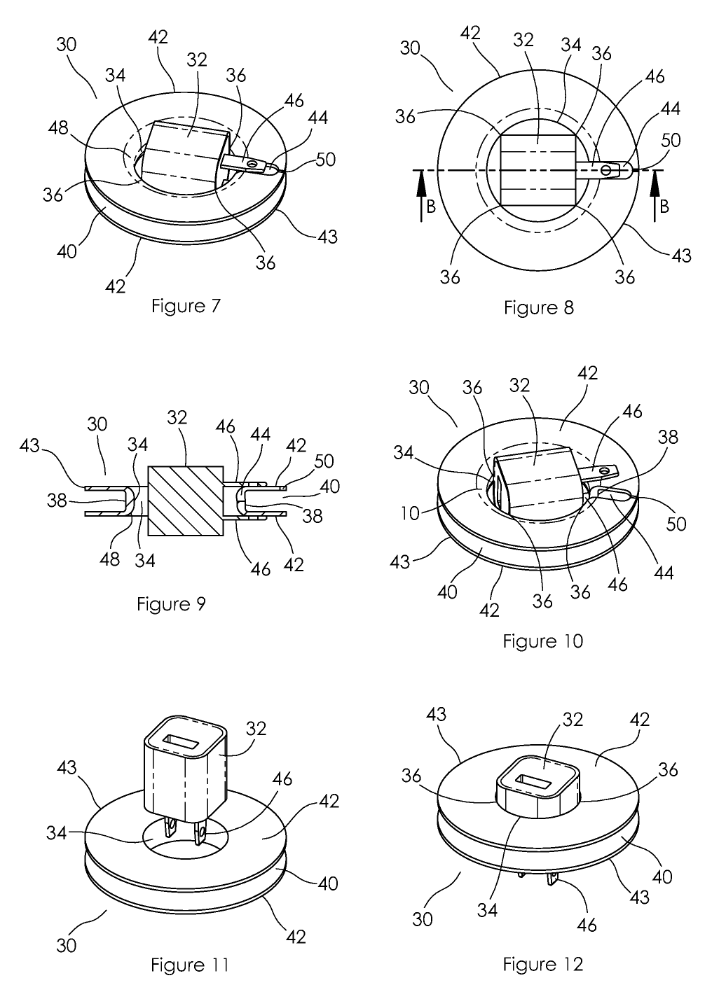

FIG. 7 shows adaptor 32 in a position of final assembly to spool 30, such that the distal portions 36 of the adaptor 32, represented by its corners, are coincident with the interior perimeter 34 of the spool 30, generally in a friction or pressure fit fashion to retain the adaptor fixedly therein.

FIGS. 8 and 9 are alternative views of the assembly of FIG. 7, FIG. 8 being a top view showing clearly the distal portions 36 of the adaptor 32 being coincident with the interior perimeter 34 of the spool 30, generally in a friction or pressure fit fashion to retain the adaptor fixedly therein, the sharp corners of the distal portions 36 of the rectangular shaped adaptor 32 touching the interior perimeter 34 of the spool 30 as seen in plan view, and FIG. 9 showing tangs 46 flush, coincident and parallel to sidewalls 42.

FIG. 10 shows adaptor 32 in a position of an additional assembly locking step within spool 30, where the adaptor 32 is rotated within interior perimeter 34, positioning tangs 46 away from slot 44 as a means to more fixedly retain adaptor 32 to spool 30, preventing the tangs 46 or adaptor 32 from twisting out of the spool 30.

### Variations:

FIG. 11 shows a second embodiment of a cable spool 30, where an adaptor 32 is positioned prior to assembly with a cable spool 30, wherein a circular interior perimeter 34 is disposed to receive the adaptor 32. The present embodiment does not feature a radius 48 between the interior perimeter 34 and a sidewall 42, though one may be present for aesthetic reasons or functional purposes to act as a funnel to aid in the insertion of the power adaptor 32.

FIG. 12 shows the embodiment of FIG. 11, where the adaptor 32 is inserted into the spool 30, where it is fixedly retained therein by friction fit between the distal portions 36 of the adaptor 32 and the interior perimeter 34 of the spool 30.

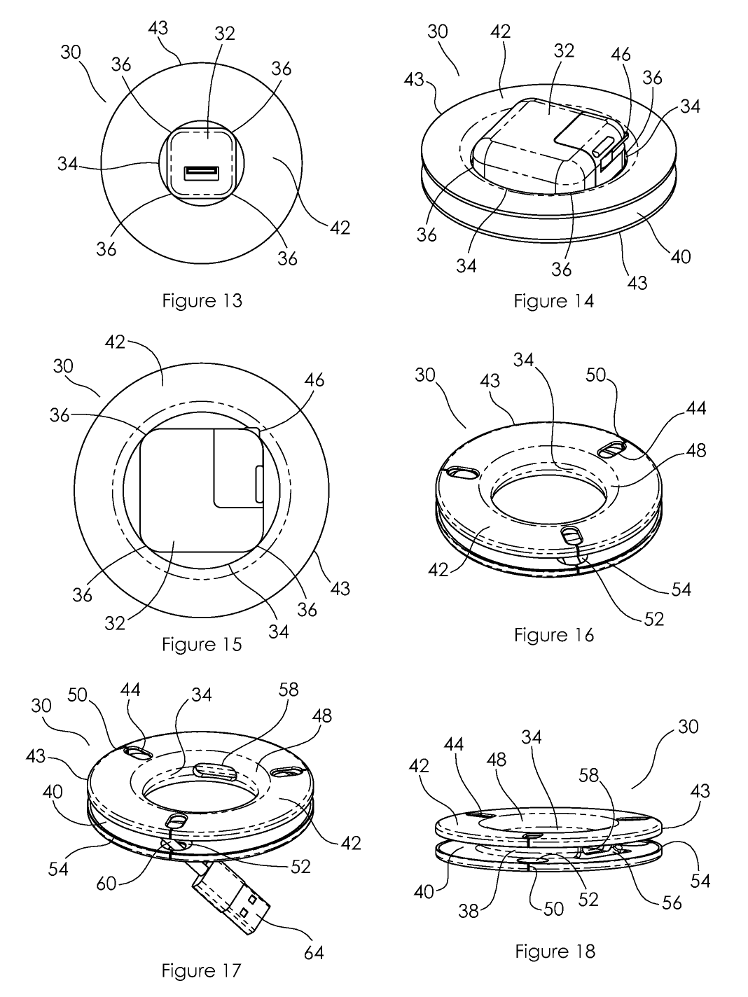

FIG. 13 shows a top plan view of the embodiment of FIG. 12, with the round, radius corners of the distal portions 36 of the square shaped adaptor 32 touching the interior perimeter 34 of the spool 30 as seen in plan view. Slots 44 and slits 50 are absent in the present embodiment, but may feature in alternative embodiments with other similar features. Where slots 44 and slits 50 are absent from an embodiment, the distal plug-end of a cable (not shown) may be jammed between the sidewalls 42 in a friction fit, or some other retention means.

FIGS. 14 and 15 shows a third embodiment of a cable spool 30 with a power adaptor 32 inserted in an interior perimeter 34 of the cable spool, where retracted tangs 46 of the adaptor 32 stick out from a distal portion 36 of the main body of the adaptor, and are accommodated by radii 48 such that the tangs 46 straddle the spool 30 in the clearance space created by the radii 48.

FIG. 16 is a perspective view of a preferred fourth embodiment of a cable spool, revealing thin flexible edges 52 around a slot 44 and a plug retention flange 54 extending from an interior surface of a sidewall 42. A circular array of three slots 44 and slits 50 are disposed to retain a portion of a cable 60 (not shown) by inserting the cable 60 through a slit 50, deforming the elastomeric material of the spool 30, where it comes to be positioned within the slot 44, the slit 50 returning back to its state at manufacture through elastic retraction and shape ‘memory’ due to the low compression set of the elastomeric material. Slots 44 may feature a narrowing of the material of the spool 30 closer to the slot 44 so that the cable 60 requires less bending to enter or exit the slot 44. The three slots 44 provide an option to the user to spool or unspool cable 60 to a desired length before retaining in an elected slot 44.

FIG. 17 is a perspective view of the fourth embodiment of a cable spool, showing a cable 60 hooked into a slot 44 in a sidewall 42, where the cable 60 is able to lie flatter due to thin flexible edges 52 around the slot 44.

FIG. 18 is a perspective view of the fourth embodiment of a cable spool, revealing a slot 44 through a spooling surface 38 to an interior perimeter 34 that provides a means to hook a proximal plug 62 (not shown) of a cable 60 (not shown) therein, and a plug retainer 56 in the form of a recess disposed to retain a proximal plug 62 (not shown).

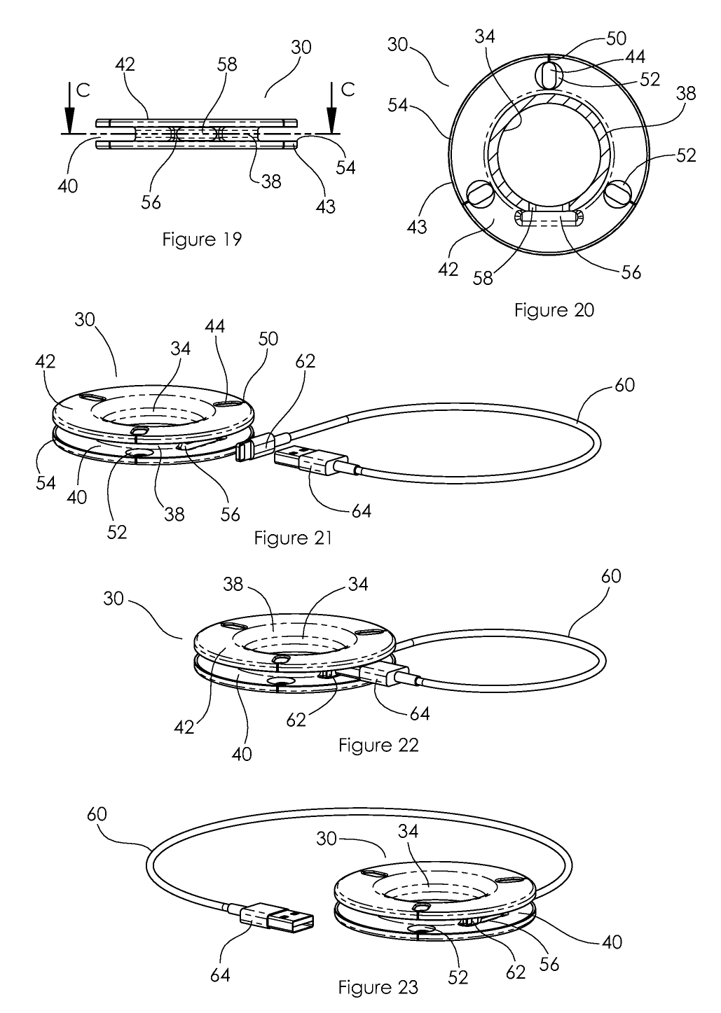

FIG. 19 is a side view of the fourth embodiment, revealing similar aspects as FIG. 18.

FIG. 20 is a section view along section line C-C as seen in FIG. 19.

FIG. 21 is a perspective view of the fourth embodiment shown with a cable 60 in proximity, with a proximal plug 62 and a distal plug 64 at either end of the cable 60, positioned in a first step of assembling the cable 60 to the cable spool 30. The proximal plug 62 is represented in this example by an Apple Lightning™ plug, and the distal plug 64 by a USB plug.

FIG. 22 is a perspective view of the spool 30 and cable 60 of FIG. 21 showing a second step of assembly, where the distal plug 64 is used to push the proximal plug 62 into a plug retainer 56 recessed within a spooling surface 38.

FIG. 23 is a perspective view of the spool 30 and cable 60 of FIG. 22 showing a third step of assembly, where the cable 60 is looped around the spool 30, prior to spooling the cable 60 into the spool 30.

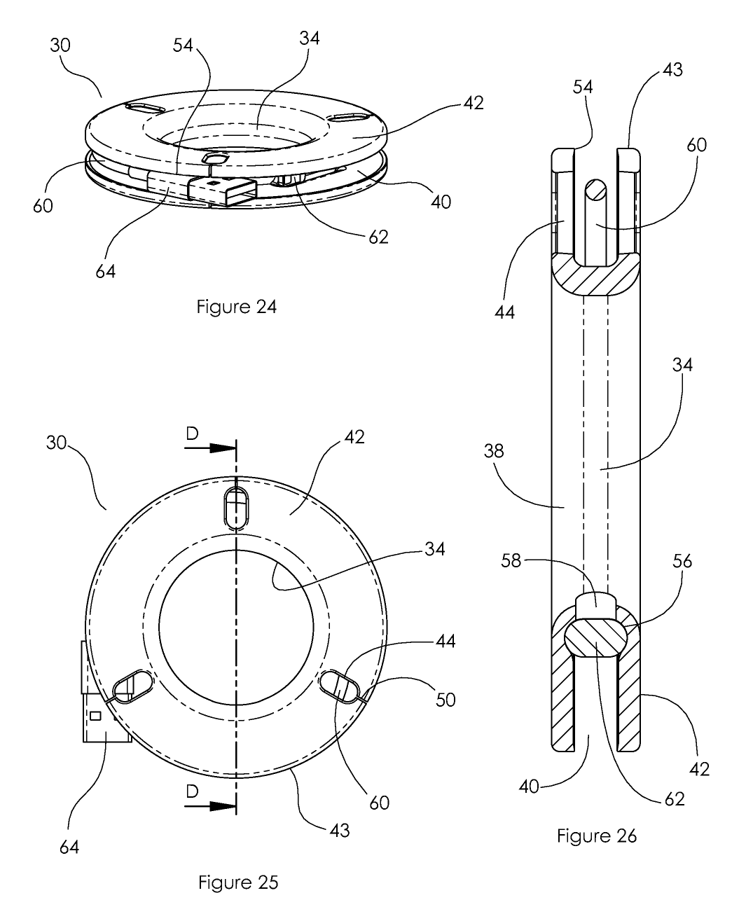

FIG. 24 is a perspective view of the spool 30 and cable 60 of FIG. 23 showing a fourth step of assembly, where the cable 60 is fully spooled around spool 30, showing the distal plug 64 retained between the sidewalls 42 of the spool 30 by friction fit, aided by plug retention flanges 54 extending from the interior portion of the sidewalls 42 that provide grip to the distal plug 64 during insertion while freely allowing the passage of the cable 60 into the gap 40 during spooling.

FIG. 25 is a top view of the assembly of FIG. 24.

FIG. 26 is a section view along section line D-D as seen in FIG. 25, revealing cable 60 within the spool 30 and a proximal plug 62 retained within the plug retainer 56 fashioned as a recess in either sidewall 42 and the spooling surface 38 of the spool 30 within the gap 40 to provide relatively even spooling of a cable 60 around the spooling surface 38 and the proximal plug 62.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. A cable spool to store a cable featuring a circular spooling surface, wherein a circular interior perimeter of the spool is disposed to retain a nominally square, rectangular or otherwise shaped power adaptor at its distal portions by friction fit.

2. A cable spool, as described in claim 1, with sidewalls extending distally from the spooling surface to retain the cable within a gap between the sidewalls.

3. A cable spool, as described in claim 2, where sidewalls are flat and parallel.

4. A cable spool, as described in claim 2, where the tangs of the power adaptor straddle the sidewalls or other portions of the spool upon assembly.

5. A cable spool, as described in claim 1, where the distal portions are the corners of a power adaptor.

6. A cable spool, as described in claim 1, where the distal portions are rounded corners of a power adaptor.

7. A cable spool, as described in claim 1, where the distal portions are two corners and the ends of the tangs of a power adaptor.

8. A cable spool, as described in claim 4, where a relief slot is disposed to facilitate straddling the tangs around the sidewalls of a cable spool during insertion by preventing interference of the tangs to the sidewalls.

9. A cable spool, as described in claim 4, where a relief slot in a sidewall is disposed to facilitate straddling the tangs around the sidewalls of a cable spool during insertion by preventing interference of a tang to a sidewall, after which upon insertion the adaptor can be rotated within the circular aperture to move the tang away from the slot to retain the adaptor therein in a locked position by creating an interference between the tang and the sidewall that would prevent the rotation of the adaptor out of the locked position.

10. A cable spool, as described in claim 4, in which a radius or notch where the interior perimeter connects to a sidewall is disposed to facilitate straddling the tangs around the sidewalls of a cable spool during insertion by preventing interference of the tangs to the sidewalls.

11. A cable spool, as described in claim 2, where a plug retainer between the sidewalls is disposed to receive a retain a plug prior to spooling.

12. A cable spool, as described in claim 11, where a tool, such as a plug at an opposing end of a cable, is used to push a plug at an end of a cable into the plug retainer.

13. A cable spool, as described in claim 2, where a plug retention flange is disposed to retain a plug between the sidewalls of the spool by mechanical or friction fit to prevent the plug from falling out of the gap, causing the cable to unspool, and without the need for slots to retain the cable.

14. A cable spool, as described in claim 2, where a slit in the flexible material of a sidewall is disposed to be deformable to provide access of a cable into a slot, where it is considered retained therein, providing a measure of retention to fix the cable in place during spooling or prevent the cable from unspooling.

15. A cable spool, as described in claim 14, where there is a circular array of three slits and slots through a sidewall of the spool.

16. A cable spool, as described in claim 1, where the material comprising it is elastomeric.

17. A cable spool, as described in claim 1, where the material comprising it is silicone.

18. A cable spool, as described in claim 1, where the material comprising it is thermoplastic.

19. A cable spool, as described in claim 1, where the material comprising it is a thermoset material.

20. A cable spool, as described in claim 1, where the spool is injection molded.

21. A cable spool, as described in claim 1, where the spool is liquid silicone rubber molded.

22. A cable spool, as described in claim 1, where the spool is vacuum casted.

23. A cable spool, as described in claim 1, where the spool is made form a single part.
